(19) United States
(12) Patent Application Publication
(10) Pub. No.: US 2021/0331236 A1
(43) Pub. Date: Oct. 28, 2021

(54) THREE-DIMENSIONAL PRINTING

(71) Applicant: HEWLETT-PACKARD DEVELOPMENT COMPANY, L.P., Spring, TX (US)

(72) Inventors: Vladek Kasperchik, Corvallis, OR (US); Mohammed S. Shaarawi, Corvallis, OR (US); James McKinnell, Corvallis, OR (US)

(21) Appl. No.: 16/605,559

(22) PCT Filed: Jul. 18, 2018
(86) PCT No.: PCT/US18/42580

§ 371 Date: Oct. 16, 2019

(51) Int. Cl. B22F 1/00; B22F 10/10; B22F 10/43

(52) U.S. Cl. CPC B22F 1/0059; B22F 10/10; B22F 10/43; B33Y 10/00; B22F 2998/10; B22F 2999/00; B22F 1/0007

(57) ABSTRACT

A three-dimensional printing kit can include a binder fluid, a gas-precursor fluid, and a particulate build material including metal particles. The binder fluid can include latex particles and an aqueous liquid vehicle. The gas-precursor fluid can include carbon black pigment dispersed in a second aqueous liquid vehicle.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material. This is unlike other machining processes, which often rely upon the removal of material to create the final part. Some 3D printing methods use chemical binders or adhesives to bind build materials together. Other 3D printing methods involve at least partial sintering, melting, etc. of the build material. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 schematically illustrates an example three-dimensional printing kit in accordance with the present disclosure;

FIG. 2 graphically illustrates an example three-dimensional printing kit in an example use in accordance with the present disclosure;

FIG. 3 graphically illustrates an example three-dimensional printing kit and use shown in FIG. 2 with further example details in accordance with the present disclosure; and

FIG. 4 is a flow diagram illustrating an example method of three-dimensional printing in accordance with the present disclosure.

### DETAILED DESCRIPTION

An example 3-dimensional (3D) printing process can be an additive process that can involve the application of successive layers of build material with chemical binders or adhesives printed thereon to bind the successive layers of build materials together. In some processes, application of binder can be utilized to form a green body object and then a fused three-dimensional physical object can be formed therefrom. More specifically, binder fluid with latex particles can be selectively applied to a layer of particulate build material on a build platform to pattern a selected region of the layer and then another layer of the particulate build material is applied thereon. The binder fluid can be applied to another layer of the particulate build material and these processes can be repeated to form a green part (also known as a green body) of the 3D printed object that is ultimately formed. The binder fluid can be capable of penetrating the layer of the particulate build material onto which it is applied, and/or spreading around an exterior surface of the particulate build material and filling void spaces between particles of the particulate build material. The binder fluid can include a binder particle, such as latex, that can hold the particulate build material of the green part together. The green part can then be exposed to heat to fuse the particulate build material of the green part together and form the 3D printed object.

In some 3D printing methods, sections of a green body may not be directly supported by the build platform during the patterning process, and/or can lack support during the fusing process, e.g., high temperature sintering, annealing, melting, etc. A lack of support can lead to deformation of sections of the green body during patterning and/or fusing. The lack of support can, in some cases, render the 3D printed object otherwise unusable, aesthetically unpleasing, or the like.

In the examples disclosed herein, a 3D support structure can be built as the green body is formed, which can provide support to the green body during patterning of the layers of the green body and in some examples, can be bound to the green body for relocation to a fusing oven. In accordance with examples of the present disclosure, an atmosphere during heating can contain hydrogen gas and gas pockets including the hydrogen can be formed throughout a 3D printed object during fusing. Thus, if the 3D (green body) printed object is printed in connection with a 3D support structure, and if the 3D support structure is adjacent to the green body object with carbon material deposited therebetween, then the hydrogen gas from the atmosphere and the deposited carbon can react under heat, e.g., during fusing in a high temperature oven, and form a breakaway interface between the 3D support structure and the 3D printed object as a result of the formation and entrapment of methane gas at the interface. These gas pockets can generate a weak point or interface between the 3D support structure and the 3D printed object and can allow the 3D support structure to be removed from the 3D printed object, such as by breaking with or without the assistance of tools.

In accordance with this, in one example, a three-dimensional printing kit can include a binder fluid, a gas-precursor fluid, and a particulate build material including metal particles. The binder fluid can include latex particles and an aqueous liquid vehicle. The gas-precursor fluid can include a carbon black pigment dispersed in a second aqueous liquid vehicle. In one example, the latex particles can be present in the binder fluid in an amount of from about 2 wt % to about 40 wt % based on the total weight of the binder fluid and the carbon black pigment can be present in the gas-precursor fluid at an amount of from about 1 wt % to about 50 wt % based on the total weight of the gas-precursor fluid. In another example, the gas-precursor fluid can further include organic co-solvent and a dispersing agent attached to or associated with a surface of the carbon black pigment. In a further example, the gas-precursor fluid can be devoid of latex particles. In one example, the particulate build material can include from about 80 wt % to 100 wt % metal particles based on a total weight of the particulate build material and the metal particles can be aluminum, titanium, copper, cobalt, chromium, nickel, vanadium, tungsten, tungsten carbide, tantalum, molybdenum, magnesium, gold, silver, stainless steel, steel, an alloy thereof, or an admixture thereof. In another example, the metal particles can have a D50 particle size distribution value of from about 0.5 μm to about 200 μm.

Also presented herein is a method of three-dimensional printing. In one example, the method can include iteratively applying individual build material layers of a particulate build material including metal particles. Building a layered green body, based on a 3D model which can include a 3D object model, a 3D support structure model, and a 3D breakaway interface model can include, selectively applying a binder fluid including latex particles and an aqueous liquid vehicle to individual build material layers to define individually patterned object layers of a 3D object based on the 3D object model and individually patterned support structure layers of a 3D support structure based on the 3D support structure model; and selectively applying a gas-precursor fluid including carbon black pigment dispersed in a second aqueous liquid vehicle to individual build material layers to define an individually patterned breakaway interface of one or multiple layers based on the 3D breakaway interface model; and heating the layered green body in an inert atmosphere containing hydrogen gas to form a fused 3D support structure, a fused 3D object, and a fused 3D breakaway interface therebetween that can be weakened by methane gas bubbles generated by reaction between the carbon black pigment and the hydrogen gas. In one example, the fused 3D breakaway interface can be positioned between the fused 3D support structure and the fused 3D object and can have a thickness from about 10 μm to about 2,000 μm. In another example, the method can further include cooling the fused 3D support structure and the fused 3D object, and separating the fused 3D support structure from the fused 3D object along the fused 3D breakaway interface. In yet another example, the heating can occur at a temperature in the range of from about 600° C. to about 1,500° C., and can include a temperature within the range where the methane gas bubbles becomes trapped between object layers and support structure layers while being fused, e.g., sintered, annealed, melted, etc. In a further example, the inert atmosphere can be oxygen-free and can include a noble gas, an inert gas, or combination thereof. The hydrogen can be present in an amount of from about 0.5 wt % to less than 100 wt %. In another example, inert atmosphere can be 100% hydrogen gas.

In another example, a three-dimensional printing kit can include a binder fluid, a gas-precursor fluid, and a particulate build material including metal particles. The binder fluid can include latex particles dispersed in an aqueous liquid vehicle. The gas-precursor fluid can include latex particles and carbon black pigment dispersed in a second aqueous liquid vehicle. In one example, the latex particles in the binder fluid and the latex particles in the gas-precursor fluid can be the same. In another example, the particulate build material can include from about 80 wt % to 100 wt % metal particles based on a total weight of the particulate build material and the metal particles can have a D50 particle size distribution value of from about 0.5 μm to about 200 μm.

It is noted that when discussing the three-dimensional printing kits and method of three-dimensional printing herein, each of these discussions can be considered applicable to one another whether or not they are explicitly discussed in the context of that example. Thus, for example, when discussing a binder fluid related to a three-dimensional printing kit, such disclosure is also relevant to and directly supported in the context of the other three-dimensional printing kits, methods of three-dimensional printing, and vice versa.

It is also understood that terms used herein will take on their ordinary meaning in the relevant technical field unless specified otherwise. In some instances, there are terms defined more specifically throughout the specification or included at the end of the present specification, and thus, these terms can have a meaning as described herein.

Particulate Build Materials

In examples of the 3D printing kits and methods disclosed herein, the same build material can be used for generating the 3D printed object, the 3D support structure, and the 3D breakaway interface. The particulate build material can include metal particles of any type that can be fused together at fusing temperature (above the temperature at which the green body is formed). Fusing can be carried out by sintering, annealing, melting, or the like, metal particles together within the particulate build material. In one example, the particulate build material can in the form of powder or small microparticles that include metal particles, and the particulate build material can have an average aspect ratio of about 1:1 to about 2:1. In another specific example, the particulate build material can include from about 80 wt % to 100 wt % metal particles based on the total weight of the particulate build material. In still another example, the metal particles can be present in the particulate build material at from about 90 wt % to about 100 wt %, or at about 100 wt % metal particles.

In an example, the build material particles can be a single phase metallic material composed of one element. In this example, the fusing, e.g., sintering, annealing, etc., can occur at a temperature can be below the melting point of the single element. In other examples, melting of particles can occur to fuse particles together. In another example, the build material particles can be composed of two or more elements, which can be in the form of a single phase metallic alloy or a multiple phase metallic alloy. In these other examples, fusing generally can occur over a range of temperatures. With respect to alloys, materials with a metal alloyed to a non-metal (such as a metal-metalloid alloy) can be used as well.

In some examples, the particulate build material can include particles of aluminum, titanium, copper, cobalt, chromium, nickel, vanadium, tungsten, tungsten carbide, tantalum, molybdenum, magnesium, gold, silver, stainless steel, steel, alloys thereof, or admixtures thereof. Specific alloy examples can include examples include AlSi 10Mg, 2xxx series aluminum, 4xxx series aluminum, CoCr MP1, CoCr SP2, maraging steel MS1, hastelloy C, hastelloy X, nickel alloy HX, inconel IN625, inconel IN718, stainless steel GP1, stainless steel 17-4PH, stainless steel 316L, stainless steel 430L titanium 6Al4V, and titanium 6Al-4V ELI7.

The temperature(s) at which the metallic particles of the particulate build material can fuse above the temperature of the environment in which the patterning portion of the 3D printing method is performed (e.g., patterning at from about 18° C. to about 300° C., and fusing at from about 500° C. to about 3,500° C.). In some examples, the metallic build material particles can have a melting point ranging from about 500° C. to about 3,500° C. In other examples, the metallic build material particles can be an alloy having a range of melting points.

The particle size of the particulate build material can be similarly sized or differently sized. In one example, the D50 particle size of the particulate build material can range from 0.5 μm to 200 μm. In some examples, the particles can have a D50 particle size distribution value that can range from about 2 μm to about 150 μm, from about 1 μm to about 100 μm, from about 1 μm to about 50 μm, etc. Individual particle sizes can be outside of these ranges, as the “D50 particle size” is defined as the particle size at which about half of the particles are larger than the D50 particle size and about half of the other particles are smaller than the D50 particle size (by weight based on the metal particle content of the particulate build material). As used herein, particle size refers to the value of the diameter of spherical particles or in particles that are not spherical can refer to the longest dimension of that particle. The particle size can be presented as a Gaussian distribution or a Gaussian-like distribution (or normal or normal-like distribution). Gaussian-like distributions are distribution curves that can appear Gaussian in their distribution curve shape, but which can be slightly skewed in one direction or the other (toward the smaller end or toward the larger end of the particle size distribution range).

That being stated, an example Gaussian-like distribution of the metal particles can be characterized generally using “D10,” “D50,” and “D90” particle size distribution values, where D10 refers to the particle size at the 10^{th} percentile, D50 refers to the particle size at the 50^{th} percentile, and D90 refers to the particle size at the 90^{th} percentile. For example, a D50 value of 25 μm means that 50% of the particles (by number) have a particle size greater than 25 μm and 50% of the particles have a particle size less than 25 μm. Particle size distribution values are not necessarily related to Gaussian distribution curves, but in one example of the present disclosure, the metal particles can have a Gaussian distribution, or more typically a Gaussian-like distribution with offset peaks at about D50. In practice, true Gaussian distributions are not typically present, as some skewing can be present, but still, the Gaussian-like distribution can be considered to be “Gaussian” as used in practice. In yet other examples, the particles can have a D50 particle size distribution value of from about 2 μm to about 100 μm, from about 5 μm to about 75 μm, from about 25 μm to about 50 μm, from about 5 μm to about 15 μm, or from about 3 μm to about 10 μm. The shape of the particles of the particulate build material can be spherical, non-spherical, random shapes, or a combination thereof.

Gas-Precursor Fluids

The gas-precursor fluid can include a gas-precursor compound that can be reactive with hydrogen gas to form methane gas. For example, carbon black particulates or pigment can be used as the active ingredient in the gas-precursor fluid. Thus, the gas-precursor fluid can be used to pattern particulate build material where it is desirable to form an interface where a 3D support structure that can be broken away or separated from a 3D object after forming the green body and fusing. As mentioned, during fusing, the 3D support structure can act to provide support to the 3D object after the latex particle binder has burned off, but in some cases, before fusing starts to occur. However, after fusing, it can be difficult to separate 3D support structures from a 3D object. Thus, the 3D breakaway interface generated by forming entrapped methane gas from the carbon black pigment (included in the gas-precursor fluid) and hydrogen gas (present in the atmosphere of the heating device, e.g., fusing oven for sintering, annealing, melting, etc.), can provide a mechanism for separation of the 3D object from the 3D support structure after fusing.

With respect to binding the particulate build material together to form the green body (prior to fusing), a separate binder fluid can be used that may include a latex polymer binder, or the gas-precursor fluid can also include latex particles therein to act as a binder at the 3D breakaway interface portions of the build. Regardless, whether a separate binder fluid is used, or latex particles are used in the gas-precursor fluid, the gas generating fluids disclosed herein can be aqueous (e.g., include water) based liquids including a gas-precursor compound(s). In other examples, the gas generating liquid functional agents disclosed herein are solvent based liquids including the gas-precursor compound(s).

As mentioned, the gas-precursor fluid can include a carbon pigment (or particulate) that acts as a precursor compound that can be activated at a temperature within the fusing temperature range (of a build material) to generate gas pockets within the build material that can be patterned with the gas generating liquid functional agent. In the examples disclosed herein, the build material support structure can be patterned with the gas-generating fluid, and as a result of the gas generation, a mechanically weak, 3D breakaway interface can be formed.

The gas-precursor fluid, including carbon black pigment dispersed in a second aqueous liquid vehicle, can be present at from about 2 wt % to about 40 wt % of the total weight percentage of the gas-precursor fluid. In other examples, the carbon black pigment can be present at from about 5 wt % to about 15 wt %, from about 10 wt % to about 20 wt %, from about 15 wt % to about 35 wt %, or at from about 5 wt % to about 25 wt %.

The carbon black is not particularly limited, as long as it can be deposited at a 3D breakaway interface and react with hydrogen to generate methane gas, for example. The carbon black pigment can be associated with a dispersant that can be either attached to the surface (self-dispersed) or otherwise associated with a surface of the black pigment (dispersed such as by a separate polymer, oligomer, surfactant, etc. adsorbed on or attracted to a surface of the black pigment, but not covalently attached).

As used herein, “self-dispersed” generally refers to pigments that can be functionalized with a dispersing agent, such as by chemical attachment of the dispersing agent to the surface of the pigment. The dispersing agent can be a small molecule or a polymer or an oligomer. The dispersing agent can be attached to such pigments to terminate an outer surface of the pigment with a charge, thereby creating a repulsive nature that reduces agglomeration of pigment particles within the liquid vehicle. In another example of a self-dispersed pigment, carbon black pigment can be surface treated, such as by light, ultra-violet radiation, and/or ozone, to modify the surface of the pigment. The surface treatment can result in carbon black pigment with an ionized surface. In one example, the surface treatment can be carried out by exposing the carbon black pigment to both light and ozone, resulting in small molecules being generated at the surface of the carbon black pigment.

With respect to a dispersed carbon black pigment, the carbon black pigment can be dispersed by a separate dispersing agent, such as a polymer, oligomer, a surfactant, etc., that is not covalently attached to the surface of the black pigment. If a separate dispersing agent, the dispersing agent can be present at from about 0.1 wt % to about 6 wt % in the second aqueous liquid vehicle, based on the total weight of the second aqueous liquid vehicle. The dispersing agent can be non-ionic, cationic, or an anionic dispersing agent. Examples of suitable dispersing agents can include self-emulsifiable, non-ionic wetting agent based on acetylenic diol chemistry (e.g., SURFYNOL® SEF from Air Products and Chemicals, Inc.), non-ionic fluorosurfactant (e.g., CAPSTONE® fluorosurfactants from DuPont, previously known as ZONYL FSO), non-ionic, ethoxylated acetylenic diol (e.g., SURFYNOL® 465 from Air Products and Chemical Inc.), ethoxylated low-foam wetting agent (e.g., SURFYNOL® 440 or SURFYNOL® CT-111 from Air Products and Chemical Inc.), ethoxylated wetting agent and molecular defoamer (e.g., SURFYNOL® 420 from Air Products and Chemical Inc.), molecular defoamers (e.g., SURFYNOL® 104E from Air Products and Chemical Inc.), secondary alcohol ethoxylates (commercially available as TERGITOL® TMN-6, TERGITOL® 15-S-7, TERGITOL® 15-S-9, etc. from The Dow Chemical Co.), dispersing agent having a hydrophilic-lipophilic balance (HLB) less than 10 (e.g., SILQUEST™ series from Momentive, including SILQUEST™ A-1230), or a combination thereof. In one example, the dispersing agent can be Tergitol® 15-S-7 (from The Dow Chemical Co.).

Thus, the carbon black pigment can be any carbon particulate that can be suspended and ejected in a gas-precursor fluid as described herein, using any dispersing technology available in formulating the gas-precursor fluid. That being stated, there are also commercially available carbon black pigment dispersions that can be used to formulate the gas-precursor fluid, such as by adding water and/or other liquid vehicle components (and latex particles in some examples). Example commercially available pigment dispersions include Monarch® 1400, Monarch® 1300, Monarch® 1100, Monarch® 1000, Monarch® 900, Monarch® 880, Monarch® 800, and/or Monarch® 700, all available from Cabot Corporation (USA); Printex® U, Printex® V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and/or Special Black 4, all available from Degussa AG (Germany); Raven® 7000, Raven® 5750, Raven® 5250, Raven® 5000, and/or Raven® 3500 available from Columbian Chemicals (USA). LHD9303 Black from Sun Chemical (USA) can also be used, for example.

In the various gas-precursor fluids described herein, these fluids can be aqueous fluids, and can include liquid vehicle ingredients, such as water, organic co-solvents, biocides, viscosity modifiers, pH adjusters, sequestering agents, preservatives, latex polymer (particularly in fluids that may be self-binding and may not receive binding properties from a separately deposited binding fluid), etc. More detail regarding the liquid vehicles that can be used is provided hereinafter.

Binder Fluids

To bind the particulate build material together during the build process to form a green body, binder fluid can be applied to the particulate build material on a layer by layer basis. In some instances, heat (below fusing temperatures) can be applied on a layer by layer basis, upon formation of a plurality of layers of the green body, or after the green body is fully formed, which can include the 3D (green body) object, the 3D (green body) support structure, and the 3D (green body) breakaway interface. The binder fluid can include, for example, latex particles as a binding agent, and an aqueous liquid vehicle. Thus, the latex particles can be used to pattern build material where it is desirable to form the 3D object, a 3D support structure, and/or a 3D breakaway interface. With respect to the 3D breakaway interface, the latex particles can be used in combination with a gas-precursor fluid to bind areas of the build material where a breakaway interface can be formed upon fusing. Thus, binding fluid can be deposited on particulate build material at the same or similar location as the gas-precursor fluid, or in one example, the gas-precursor fluid can be formulated with latex particles so that it is a self-binding gas-precursor fluid.

The latex particles can be present at from about 2 wt % to about 40 wt % based on the total weight of the binder fluid (or at the same concentration range when present in a gas-precursor fluid). In other more detailed examples, the latex particles can be present at from about 10 wt % to about 40 wt %, from about 20 wt % to about 40 wt %, from about 5 wt % to about 35 wt %, from about 5 wt % to about 15 wt %, from about 3 wt % to about 20 wt %, or from about 30 wt % to about 40 wt %.

The latex particles can be a polymer that can have different morphologies. In one example, the latex particles can include two different copolymer compositions, which can be fully separated core-shell polymers, partially occluded mixtures, or intimately comingled as a polymer solution. In another example, the latex particles can be individual spherical particles containing polymer compositions of hydrophilic (hard) component(s) and/or hydrophobic (soft) component(s) that can be interdispersed. In one example, the interdispersion can be according to IPN (interpenetrating networks). In yet another example, the latex particles can be composed of a hydrophobic core surrounded by a continuous or discontinuous hydrophilic shell. For example, the particle morphology can resemble a raspberry, in which a hydrophobic core can be surrounded by several smaller hydrophilic particles that can be attached to the core. In yet another example, the latex particles can include 2, 3, or 4 or more relatively large polymer particles that can be attached to one another or can surround a smaller polymer core. In a further example, the latex particles can have a single phase morphology that can be partially occluded, can be multiple-lobed, or can include any combination of any of the morphologies disclosed herein.

In some examples, the latex particles can be heteropolymers or copolymers. As used herein, a heteropolymer can include a hydrophobic component and a hydrophilic component. A heteropolymer can include a hydrophobic component that can include from about 65% to about 99.9% (by weight of the heteropolymer), and a hydrophilic component that can include from about 0.1% to about 35% (by weight of the heteropolymer). In one example, the hydrophobic component can have a lower glass transition temperature than the hydrophilic component.

In some examples, the latex particles can be composed of a polymerization or co-polymerization of acrylic monomers, styrene monomers, or a combination thereof. Examples of monomers can include C1-C8 alkyl methacrylate, alkyl acrylate, styrene, methyl styrene, polyol acrylate, methacrylate, hydroxyethyl acrylate, acrylic acid, methacrylic acid, or a combination thereof. In yet other examples, a composition of the latex particles can include polymerized monomers of vinyl, vinyl chloride, vinylidene chloride, vinyl ester, acrylate, methacrylate, styrene, ethylene, maleate esters, fumarate esters, itaconate esters, α-methyl styrene, p-methyl styrene, methyl methacrylate, hexyl acrylate, hexyl methacrylate, butyl acrylate, butyl methacrylate, ethyl acrylate, ethyl methacrylate, propyl acrylate, propyl methacrylate, 2-ethylhexyl acrylate, 2-ethylhexyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, isobornyl methacrylate, cyclohexyl methacrylate, trimethyl cyclohexyl methacrylate, t-butyl methacrylate, n-octyl methacrylate, lauryl methacrylate, trydecyl methacrylate, alkoxylated tetrahydrofurfuryl acrylate, isodecyl acrylate, isobornylmethacrylate, isobornyl acrylate, dimethyl maleate, dioctyl maleate, acetoacetoxyethyl methacrylate, diacetone acrylamide, N-vinyl imidazole, N-vinylcarbazole, N-Vinyl-caprolactam, combinations thereof, derivatives thereof, or mixtures thereof. These monomers include low glass transition temperature (Tg) monomers that can be used to form the hydrophobic component of a heteropolymer.

In other examples, a composition of the latex particles can include acidic monomers. In some examples, the acidic monomer content can range from about 0.1 wt % to about 15 wt %, from about 0.5 wt % to about 12 wt %, or from about 1 wt % to about 10 wt % of the latex particles with the remainder of the latex particle being composed of non-acidic monomers. Examples of acidic monomers can include acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, combinations thereof, derivatives thereof, or mixtures thereof. These acidic monomers are higher Tg hydrophilic monomers, than the low Tg monomers above, and can be used to form the hydrophilic component of a heteropolymer. Other examples of high Tg hydrophilic monomers can include acrylamide, methacrylamide, monohydroxylated monomers, monoethoxylated monomers, polyhydroxylated monomers, or polyethoxylated monomers.

In an example, the selected monomer(s) can be polymerized to form a polymer, heteropolymer, or copolymer with a co-polymerizable dispersing agent. The co-polymerizable dispersing agent can be a polyoxyethylene compound, such as a HITENOL® compound (Montello Inc.) e.g., polyoxyethylene alkylphenyl ether ammonium sulfate, sodium polyoxyethylene alkylether sulfuric ester, polyoxyethylene styrenated phenyl ether ammonium sulfate, or mixtures thereof. Any suitable polymerization process can be used. In some examples, an aqueous dispersion of latex particles can be produced by emulsion polymerization or co-polymerization of any of the above monomers.

In one example, the latex particles can be prepared by polymerizing high Tg hydrophilic monomers to form the high Tg hydrophilic component and attaching the high Tg hydrophilic component onto the surface of the low Tg hydrophobic component. In another example, the latex particles can be prepared by polymerizing the low Tg hydrophobic monomers and the high Tg hydrophilic monomers at a ratio of the low Tg hydrophobic monomers to the high Tg hydrophilic monomers that ranges from 5:95 to 30:70. In this example, the low Tg hydrophobic monomers can dissolve in the high Tg hydrophilic monomers. In yet another example, the latex particles can be prepared by polymerizing the low Tg hydrophobic monomers, then adding the high Tg hydrophilic monomers. In this example, the polymerization process can cause a higher concentration of the high Tg hydrophilic monomers to polymerize at or near the surface of the low Tg hydrophobic component. In still another example, the latex particles can be prepared by copolymerizing the low Tg hydrophobic monomers and the high Tg hydrophilic monomers, then adding additional high Tg hydrophilic monomers. In this example, the copolymerization process can cause a higher concentration of the high Tg hydrophilic monomers to copolymerize at or near the surface of the low Tg hydrophobic component.

Other suitable techniques, specifically for generating a core-shell structure can include, grafting a hydrophilic shell onto the surface of a hydrophobic core, copolymerizing hydrophobic and hydrophilic monomers using ratios that lead to a more hydrophilic shell, adding hydrophilic monomer (or excess hydrophilic monomer) toward the end of the copolymerization process so there is a higher concentration of hydrophilic monomer copolymerized at or near the surface, or any other method can be used to generate a more hydrophilic shell relative to the core.

In one specific example, the low Tg hydrophobic monomers can be C4 to C8 alkyl acrylate monomers, C4 to C8 alkyl methacrylate monomers, styrene monomers, substituted methyl styrene monomers, vinyl monomers, vinyl ester monomers, or combinations thereof. Furthermore, the high Tg hydrophilic monomers can be selected from acidic monomers, unsubstituted amide monomers, alcoholic acrylate monomers, alcoholic methacrylate monomers, C1 to C2 alkyl acrylate monomers, C1 to C2 alkyl methacrylate monomers, and combinations thereof. The resulting polymer latex particles can exhibit a core-shell structure, a mixed or intermingled polymeric structure, or some other morphology.

In some examples, the latex polymer can have a weight average molecular weight (Mw) that can range from 5,000 Mw to 500,000 Mw. In yet other examples, the weight average molecular weight can range from 100,000 Mw to 500,000 Mw, from 150,000 Mw to 300,000 Mw, or from 50,000 Mw to 250,000 Mw.

In some examples, the latex polymer particles can be latent and can be activated by heat (applied iteratively or after green body formation). In these instances, the activation temperature can correspond to the minimum film formation temperature (MFFT) or a glass transition temperature (Tg) which can be greater than ambient temperature. As mentioned herein, “ambient temperature” can refer to room temperature (e.g., ranging about 18° C. to about 22° C.). In one example, the latex polymer particles can have a MFFT or Tg that can be at least 15° C. greater than ambient temperature. In another example, the MFFT or the Tg of the bulk material (e.g., the more hydrophobic portion) portion of the latex polymer particles can range from about 25° C. to about 200° C. In another example, the latex particles can have a MFFT or Tg ranging from about 40° C. to about 120° C. In yet another example, the latex polymer particles can have a MFFT or Tg ranging from about 50° C. to about 150° C. In a further example, the latex polymer particles can have a Tg that can range from about −20° C. to about 130° C., or in another example from about 60° C. to about 105° C. At a temperature above, the MFFT or the Tg of a latent latex polymer particle, the polymer particles can coalesce and can bind materials.

The latex particles can have a particle size that can be jetted via thermal inkjet printing, piezoelectric printing, or continuous inkjet printing. In an example, the particle size of the latex particles can range from about 10 nm to about 400 nm. In yet other examples, a particle size of the latex particles can range from about 10 nm to about 300 nm, from about 50 nm to about 250 nm, from about 100 nm to about 300 nm, or from about 25 nm to about 250 nm.

In the various binder fluids described herein, these fluids can be aqueous fluids, and can include liquid vehicle ingredients, such as water, organic co-solvents, biocides, viscosity modifiers, pH adjusters, sequestering agents, preservatives, latex polymer, etc. More detail regarding the liquid vehicles that can be used is provided hereinafter.

Aqueous Liquid Vehicle

Turning now to the aqueous liquid vehicle that can be used for binder fluid and/or the gas-precursor fluid (sometimes referred to as a “second” aqueous liquid vehicle), these vehicles can include from about 60 wt % to about 98 wt % of the binder fluid and/or from about 60 wt % to about 99 wt % the gas-precursor fluid. In yet other examples, the aqueous liquid vehicle can include from about 60 wt % to about 90 wt %, from about 60 wt % to about 80 wt %, from about 65 wt % to about 95 wt %, from about 85 wt % to about 95 wt %, from about 80 wt % to about 97 wt %, or from about 60 wt % to about 70 wt % of the various fluids, based on a total weight of the binder fluid or the total weight of the gas-precursor fluid.

In some examples, the aqueous liquid vehicle can include water, co-solvents, dispersing agents, biocides, viscosity modifiers, pH adjusters, sequestering agents, preservatives, and the like. In one example, water can be present at from about 30 wt % to 100 wt % (of the liquid vehicle component—excluding latex polymer binder and carbon black pigment) based on a total weight of the aqueous liquid vehicle components excluding the carbon black pigment and/or latex particulate binder. In other examples, the water can be present in its respective fluid, e.g., binder fluid or gas-precursor fluid at from about 60 wt % to about 95 wt %, from about 75 wt % to 100 wt %, or from about 80 wt % to about 99 wt %, based on a total weight of the respective fluid, e.g., aqueous vehicle, latex particles, carbon black pigment, and other additives.

The co-solvent can be present at from about 0.5 wt % to about 50 wt % based on a total weight of the binder fluid or the total weight of the gas-precursor fluid. In some examples, the co-solvent can be a high boiling point solvent, which can have a boiling point of at least about 110° C. Examples of co-solvents can include aliphatic alcohols, aromatic alcohols, alkyl diols, glycol ethers, polyglycol ethers, 2-pyrrolidinones, caprolactams, formamides, acetamides, long chain alcohols, and combinations thereof. For example, the co-solvent can include aliphatic alcohols with a —CH₂OH group, secondary aliphatic alcohols, 1,2-alcohols, 1,3-alcohols, 1,5-alcohols, ethylene glycol alkyl ethers, propylene glycol alkyl ethers, C6 to C12 homologs of polyethylene glycol alkyl ethers, N-alkyl caprolactams, unsubstituted caprolactams, both substituted and unsubstituted formamides, both substituted and unsubstituted acetamides, combinations thereof, and the like. Other example organic co-solvents can include propyleneglycol ether, dipropyleneglycol monomethyl ether, dipropyleneglycol monopropyl ether, dipropyleneglycol monobutyl ether, tripropyleneglycol monomethyl ether, tripropyleneglycol monobutyl ether, dipropyleneglycol monophenyl ether, 2-pyrrolidinone, 2-methyl-1,3-propanediol, and combinations thereof.

If a surfactant is included, examples can include SURFYNOL® SEF, SURFYNOL® 104, or SURFYNOL® 440 (Evonik Industries AG, Germany); CRODAFOS™ N3 Acid or BRIJ® 010 (Croda International Plc., Great Britain); TERGITOL® TMN6, TERGITOL® 15S5, TERGITOL® 15S7, DOWFAX® 2A1, or DOWFAX® 8390 (Dow, USA); or a combination thereof. The surfactant or combinations of surfactants can be present in the binder fluid or the gas precursor fluid based on a total weight of the fluid at from about 0.1 wt % to about 5 wt % in its respective fluid based on the total fluid content weight, and in some examples, can be present at from about 0.5 wt % to about 2 wt %.

The aqueous liquid vehicle can include from about 0.01 wt % to about 1 wt %, based on a total weight percentage of the binder fluid or the total weight of the gas-precursor fluid, of an additive that can inhibit a growth of harmful microorganisms such as biocides and fungicides. These additives can be biocides, fungicides, and other microbial agents. Examples of suitable microbial agents can include, but are not limited to, NUOSEPT® (Troy, Corp.), UCARCIDE™, KORDEK™, ROCIMA™, KATHON™ (all available from The Dow Chemical Co.), VANCIDE® (R.T. Vanderbilt Co.), PROXEL® (Arch Chemicals), ACTICIDE® B20 and ACTICIDE® M20 and ACTICIDE® MBL (blends of 2-methyl-4-isothiazolin-3-one (MIT), 1,2-benzisothiazolin-3-one (BIT), and Bronopol (Thor Chemicals); AXIDE™ (Planet Chemical); NIPACIDE™ (Clariant), etc.

Sequestering agents such as EDTA (ethylene diamine tetra acetic acid) can be included to eliminate the deleterious effects of heavy metal impurities, and buffer solutions can be used to control the pH of the ink. Viscosity modifiers and buffers can also be present, as well as other additives modify properties of the respective fluids.

In some examples, the aqueous liquid vehicle(s) can include from about 0.1 wt % to about 1 wt % of an anti-kogation agent, based on a total weight percentage of the binder fluid or the total weight of the adhesion promoter fluid. Kogation refers to the deposit of dried solids on a printhead. An anti-kogation agent can be included to prevent the buildup of dried solids on the printed. Examples of suitable anti-kogation agents can include oleth-3-phosphate (commercially available as CRODAFOS™ O3A or CRODAFOS™ N-3 acid), dextran 500k, CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

Three-Dimensional Printing Kits and Methods of Three-Dimensional Printing

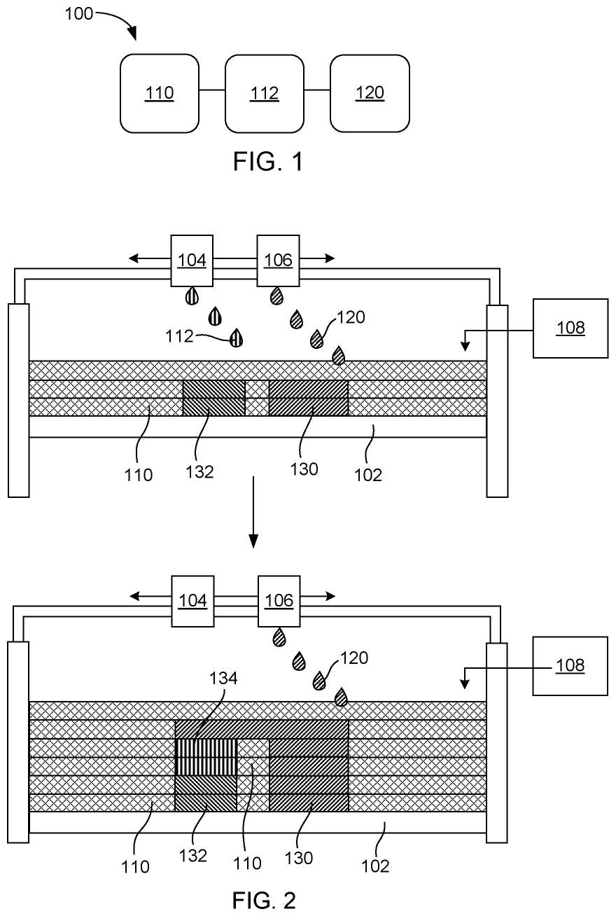

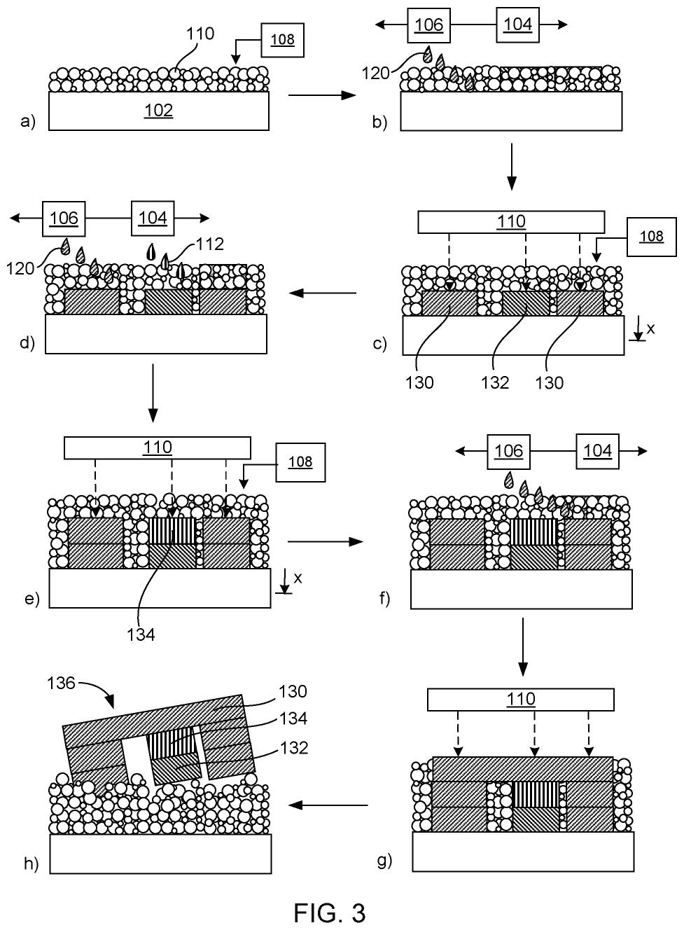

In further detail, as shown in FIG. 1, a 3D printing kit 100 can include a particulate build material 110, a gas-precursor fluid 112 including carbon black pigment dispersed in a second aqueous liquid vehicle, and a binder fluid 120 including latex particles and an aqueous liquid vehicle. In one example, the gas-precursor fluid also includes latex particles so that the binder fluid may or may not be used in conjunction with the gas-precursor fluid for purposes of binding the particulate build material at the 3D breakaway interface, for example.

In FIG. 2, the 3D printing kit shown at 100 in FIG. 1 is shown by example in use where the particulate build material 110 is deposited from a particulate build material source 108 onto a build platform 102 where it can be flattened or smoothed, such as by a mechanical roller or other flattening technique. The various fluids 112,120 in this example are shown as being ejectable from fluid ejectors 104, 106, for example. Thus, in this example, fluid ejectors can deposit the gas-precursor fluid and binder fluid onto a selected portion of the particulate build material. The binder fluid, for example, can be used to form either the 3D object layers 130 or 3D support material layers 132, and the gas-precursor fluid can be used to form 3D breakaway interface layers 134, which in this example are two layers in thickness. For either type of fluid, the fluid ejectors can be a thermal fluid ejector, piezo electric fluid ejector, or another type of fluid ejector.

The ejectors can deposit the gas-precursor fluid and/or the binder fluid in a layer that corresponds to the layers of the 3D object, layers of the 3D support structure, or layers of the 3D breakaway interface. The printing of 3D object can occur in any orientation. For example, the 3D object can be printed from bottom to top, top to bottom, on its side, at an angle, or any other orientation. The orientation of the 3D object can also be formed in any orientation relative to the layering of the particulate build material. For example, the 3D object can be formed in an inverted orientation or on its side relative to the build layering within the particulate build material. The orientation of build or the orientation of the 3D object to be built within the particulate build material can be selected in advance or even by the user at the time of printing, for example.

In still further detail, the 3D printing kit shown at 100 in FIG. 1 is shown further in the context of a method of three-dimensional printing. As in FIG. 2, a printing kit can include the particulate build material 110, the gas-precursor fluid 112, and the binder fluid 120, which can be used to layer the particulate build material on a build platform 102 where layers of the build material can selectively receive gas-precursor fluid and/or binder fluid droplets printed thereon from fluid ejectors 104 and 106, respectively. The location of the selective printing of the binder fluid can be a layer corresponding to a layer of a 3D printed object 130 and/or a layer of a 3D support structure 132. Heat can be used, such as from a heat source 110, at the various layers (or group of layers, or after the green body is formed) to remove solvent from the binder fluid and/or gas-precursor fluid, which can assist with more rapid solidification of individual layers. In one example, heat can be applied from overhead, e.g., prior to application of the next layer of particulate build material, or after multiple layers are formed, etc.), and/or can be provided by the build platform from beneath the particulate build material. The gas-precursor fluid can be selectively printed in a layer (or layers) corresponding to a 3D breakaway interface 134. The 3D breakaway interface can be positioned between the 3D support structure and the 3D object to provide temporary support to the 3D object while in a green body state and through the fusing process. After individual layers are printed with binder fluid, gas-precursor fluid, or both, and then in some instances heated to solidify the layer, the build platform can be dropped a distance of (x), which can correspond to the thickness of a printed layer in one example, so that another layer of the particulate build material can be added thereon, printed with one or both fluids, solidified, etc. The process can be repeated on a layer by layer basis until a green body 136 is formed that is stable enough to move to an oven suitable for fusing, e.g., sintering, annealing, melting, or the like. The green body in this example includes, the 3D object 130 of solidified green body object layers, the 3D support structure including a solidified green body support structure layer(s), and the 3D breakaway interface including a solidified green body breakaway layer(s). The 3D support structure 132 and the 3D breakaway interface 134 (which in this example is shown as a single layer, but could be multiple layers) can provide support to the green body object when removing from the particulate build material and transferring to a fusing oven. Furthermore, the 3D support structure with the 3D breakaway interface can provide support to the 3D object during fusing of the particulate build material together as well as provide a mechanism to remove the 3D support structure therefrom after fusing via the 3D breakaway interface.

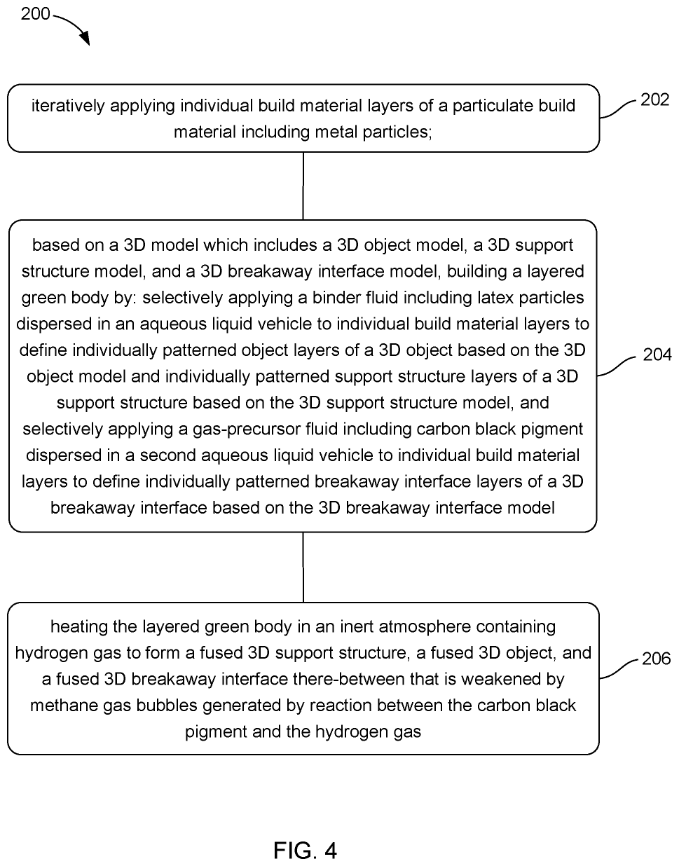

In still another example, as shown in FIG. 4, a method 200 of three-dimensional printing can include iteratively applying 202 individual build material layers of a particulate build material. In further detail, based on a 3D model which includes a 3D object model, a 3D support structure model, and a 3D breakaway interface model, the method can further include building 204 a layered green body by: selectively applying a binder fluid including latex particles and an aqueous liquid vehicle to individual build material layers to define individually patterned object layers of a 3D object based on the 3D object model and individually patterned support structure layers of a 3D support structure based on the 3D support structure model, and selectively applying a gas-precursor fluid including carbon black pigment dispersed in a second aqueous liquid vehicle to individual build material layers to define individually patterned breakaway interface layers of a 3D breakaway interface based on the 3D breakaway interface model. The method can further include heating 206 the layered green body in an inert atmosphere containing hydrogen gas to form a fused 3D support structure, a fused 3D object, and a fused 3D breakaway interface therebetween that is weakened by methane gas bubbles generated by reaction between the carbon black pigment and the hydrogen gas.

The binder fluid, gas-precursor fluid, and particulate build material can be as described above. The particulate build material can be layered at a thickness that can range from about 50 μm to about 300 μm, for example. The respective layers can be patterned one layer at a time until the 3D support structure, 3D breakaway interface, and 3D object are formed as a green body. A thickness of these various types of structures can be adjusted based on the thickness of individual layers of the particulate build material and the number of layers of the particulate build material that generated. In one example, the 3D breakaway interface can have a thickness from about 10 μm to about 2,000 μm. In yet other examples, the thickness can range from about 20 μm to about 1,000 μm, from about 50 μm to about 500 μm, or from about 75 μm to about 1,500 μm. In one example, the gas-precursor fluid can be printed at from 1 layer to 15 consecutive layers to form a single 3D breakaway interface. In other examples, the gas-precursor fluid can be printed at from 1 to 5 layers, from 2 layers to 10 layers, from 3 layers to 9 layers, or from 4 layers to 8 layers.

Following application of the binder fluid and/or the gas-precursor fluid on the particulate build material, in some instances, the particulate build material, binder fluid, and gas-precursor fluid applied thereto can be heated to an elevated temperature to assist with solidifying the green body (which includes the 3D object, 3D support structure, and 3D breakaway interface). For example, heating can occur when the binder fluid incorporates a latent latex binder that can be heat activated. In this example, the elevated temperature can be at or above the MFFT or the Tg of the latex binder. Heat can also or alternatively be applied to more rapidly remove solvent from the binder fluid and/or gas precursor fluid. In some instances, the elevated temperature can be applied by a heated build platform; a heated particulate build material, e.g., preheated prior to dispensing; an overhead heating source, such as a heat lamp, e.g., an ultra-violet lamp or an infrared lamp; or a combination thereof. Further, the heating can occur upon application of the binder fluid to each layer or following application of all the printed binder fluid.

Upon coalescing or otherwise binding of the particulate build material by the latex particles (either upon application or following heating), the 3D object, 3D support structure(s), and 3D breakaway interface(s) can be moved to a fusing/heating device, such as a sintering or annealing oven. In one example, the heating can be a temperature ranging from about 500° C. to about 3,500° C., including at a temperature within the range where the metal particles are fused together. In another example, the temperature can range from about 600° C. to about 1,500° C., or from about 800° C. to about 1200° C. As the particulate build material heats up, the latex of the binder fluid (and in some cases also from the gas-precursor fluid) can burn off and become ineffective or less effective prior to metal particle fusing of adjacent metal particles together. Thus, the 3D support structures can act to prevent portions of the 3D object from sagging until any stage of fusing occurs, e.g., initial sintering where particles may form surface bridges between particles to the melting together of adjacent metal particles. Then, after removal and cooling, the 3D support structure(s) can be removed along the 3D breakaway interface, as described herein previously.

During heating, the heating device can include an inert atmosphere containing hydrogen gas. In one example, the inert atmosphere can be oxygen-free and can include a noble gas, an inert gas, or combination thereof. For example, the inert atmosphere can include a noble gas or an inert gas selected from argon, nitrogen, helium, neon, krypton, xenon, radon, hydrogen, or a combination thereof, with the proviso that there is at least some hydrogen present for the purpose of forming methane gas when the hydrogen diffuses into the part and chemically interacts with the carbon to form methane gas. In some examples, hydrogen can be present in the inert atmosphere at an amount of from about 0.5 wt % to less than 100 wt %. In one example, the atmosphere can include from about 2 wt % to 100 wt % hydrogen. In another example, the inert atmosphere can be 100% hydrogen gas. In yet another example, the atmosphere can include from about 80 wt % to about 98 wt % nitrogen and from about 2 wt % to about 20 wt % hydrogen gas.

The hydrogen gas can react with carbon black pigment in the gas-precursor fluid (now part of the 3D breakaway interface of the green body prior to fusing), as shown below, to form methane gas.

C+2H₂→CH₄(gas)

As the methane gas is generated, pockets of methane gas are also formed by entrapment within the green body as it is in the process of fusing or just prior to fusing. These entrapped pockets of methane gas can create pores at the 3D breakaway interface which can compromise the structural integrity of this layer(s).

The eventual fusing temperature range can vary, depending on the material, but in one example, the fusing temperature can range from about 10° C. below the melting temperature of the metal particles of the particulate build material to about 50° C. below the melting temperature of the metal particles of the particulate build material. In another example, the fusing temperature can range from about 100° C. below the melting temperature of the metal particles of the particulate build material to about 200° C. below the melting temperature of the metal particles of the particulate build material. The fusing temperature can depend upon the particle size and period of time that heating occurs, e.g., at a high temperature for a sufficient time to cause particle surfaces to become physically merged or composited together). For example, a fusing temperature for stainless steel can be about 1400° C. and an example of a fusing temperature for aluminum or aluminum alloys can range from about 550° C. to about 620° C. Temperatures outside of these ranges can be used as determined on a case by case basis. The fusing temperature can sinter and/or otherwise fuse the metal particles to form a printed 3D object and a printed 3D support structure that can be broken away from the 3D object that is being printed.

In further detail, after fusing (which may be an annealing and sintering process), the method can further include cooling the fused 3D support structure and the fused 3D object, and separating the fused 3D support structure from the fused 3D object along the fused 3D breakaway interface. Separating can be accomplished using sand blasting, bead blasting, air jetting, tumble finishing such as barrel finishing, vibratory finishing, or a combination thereof. Tumble or vibratory finishing techniques can be performed wet (involving liquid lubricants, cleaners, or abrasives) or dry. If not already released, in some examples, any residual methane gas that may be still entrapped within the 3D breakaway interface can be released when the 3D object is ultimately separated from the 3D support structure.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “devoid” refers to a numerical quantity that can be zero or can be substantially zero, e.g., a quantity may be permissible in trace amounts, such as up to about 0.1 wt % of a formulation or composition.

As used herein, the phrase “green part,” “green body,” and “layered green body” refers to any intermediate structure prior to any particle to particle material fusing, including a green 3D object or object layer(s), a green 3D support structure or support structure layer(s), or an intermediate 3D breakaway interface or breakaway interface layer(s). In some instances, the term “green body” can be used to describe a printed object or part that includes all three types of part components, e.g., 3D object portions, 3D support structure portions, and 3D breakaway interface portions. As a green body, the particulate build material can be (weakly) bound together by one or more components of a binder fluid latex, gas-precursor fluid latex. Typically, a mechanical strength of the green body is such that it can be handled or extracted from a build platform to place in a fusing oven. It is to be understood that any build material that is not patterned with the binder fluid and/or gas-precursor fluid is not considered to be part of the green body, even if it is adjacent to or surrounds the green body. For example, unprinted particulate build material acts to support the green body while contained therein, but the particulate build material is not part of the green body unless it is printed with binder fluid, gas-precursor fluid, or some other fluid that is used to generate a solidified part prior to fusing, e.g., sintering, annealing, melting, etc.

As used herein, the phrase “3D support structure” or “support structure” refers to at least one layer of particulate build material that is patterned with the binder fluid. The 3D support structure can be positioned adjacent to at least a portion of the green body. The 3D support structure provides support for i) additional layer(s) of build material that are patterned with the binding fluid, and/or ii) patterned layers during fusing, for example. The 3D support structure can be referred to as a “fused” 3D support structure, indicating it has been fused such as by sintering, annealing, melting, etc., or a “green body” or “green” 3D support structure, indicating it has been solidified, but not fusing.

As used herein, “3D breakaway interface” and “breakaway interface” refers to a section of the particulate build material having a gas-precursor fluid applied thereto. The 3D breakaway interface can be a single layer thick or multiple layers thick. After fusing, the 3D breakaway interface is where the fused 3D support structure and fused 3D object are separated. The 3D breakaway interface can be referred to as a “fused” 3D breakaway interface, indicating it has been fused such as by sintering, annealing, melting, etc., or a “green body” or “green” 3D breakaway interface, indicating it has been solidified, but not fused.

As used herein, the terms “3D part,” “3D object,” or the like, refer to the target 3D object that is being built, but does not include the 3D support structure, nor does it include the 3D breakaway interface. The 3D object can be referred to as a “fused” 3D object, indicating it has been fused such as by sintering, annealing, melting, etc., or a “green body” or “green” 3D object, indicating it has been solidified, but not fused.

As used herein, the “gas-precursor fluid” refers to a fluid that can include water and carbon black pigment dispersed therein that can react with hydrogen during heating of the green body to generate methane gas pockets at the 3D breakaway interface. “Gas pockets” can be voids, spaces, or pores that can be formed among the particulate build material and/or coalesced build material as a product of a reaction involving the carbon black pigment and hydrogen gas during heating of the green body. In some examples, the gas-precursor fluid can be a separate agent used in combination with the binder fluid. In these examples, the gas-precursor fluid does not include latex particles. In other examples, the gas-precursor fluid can include latex particles that can be used to bind particulate build material where the gas-precursor fluid has been applied.

“Binder fluid” refers to a fluid that includes water and latex particles that are effective for binding layers of particulate build material when forming a green body. The binder fluid is typically applied to form a green body 3D object and a green body 3D support structure, and in some cases, is also applied at green body 3D breakaway interface locations, particularly when the gas-precursor fluid does not included latex particles.

The term “fluid” does not infer that the composition is free of particulate solids, but rather, can include solids dispersed therein, including carbon black pigment, latex particles, or other solids that are dispersed in the liquid vehicle of the fluid.

As used herein, “material set” or “kit” can be synonymous with and understood to include a plurality of compositions comprising one or more components where the different compositions can be separately contained in one or more containers prior to and during use, e.g., building a 3D object, 3D support structure, and/or 3D breakaway interface, but these components can be combined together during a build process. The containers can be any type of a vessel, box, or receptacle made of any material.

The term “fuse,” “fusing,” “fusion,” or the like refers to the joining of the material of adjacent particles of a particulate build material, such as by sintering, annealing, melting, or the like, and can include a complete fusing of adjacent particles into a common structure, e.g., melting together, or can include surface fusing where particles are not fully melted to a point of liquefaction, but which allow for individual particles of the particulate build material to become bound to one another, e.g., forming material bridges between particles at or near a point of contact.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as if each numerical value and sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Preparation of Binder Fluid

A binder fluid is prepared in accordance with Table 1, as follows:

TABLE 1
Binder Fluid

| | | Formulation |
|---|---|---|
| Component Type | Components | (wt %) |
| Co-solvent | 2-methyl-1,3-propanediol | 9.70 |
| | 2-pyrrolidinone | 17.89 |
| Surfactant | Tergitol ® 15-S-7 | 0.90 |
| Antimicrobial | Acticide ® M20 | 0.1 |
| | (stock solution) | |
| Latex Particles | Acrylic latex dispersion | 38.65 |
| | (~40 wt. % solids) | |
| Water | Deionized Water | 32.76 |

Tergitol® is available from Sigma Aldrich (USA); and Acticide® is available from Thor Group Limited (USA).

### Example 2—Preparation of Gas-Precursor Fluids

Two gas-precursor fluids are prepared in accordance with Tables 2A and 2B, as follows:

TABLE 2A
Gas-precursor Fluid without Latex Particles

| | | Formulation |
|---|---|---|
| Component Type | Components | (wt %) |
| Co-solvent | 2-pyrrolidone | 18 |
| Surfactant | Tergitol ® 15-S-7 | 1.00 |
| Antimicrobial | Acticide ® M20 | 0.1 |
| | (stock solution) | |
| Carbon Black Pigment | Monarch ® 1300 | 13.04 |
| Water | Deionized Water | Balance |

TABLE 2B
Gas-precursor Fluid with Latex Particles

| | | Formulation |
|---|---|---|
| Component Type | Components | (wt %) |
| Co-solvent | 2-methyl-1,3-propanediol | 9.7 |
| | 2-pyrrolidinone | 18.0 |
| Surfactant | Tergitol ® 15-S-7 | 1.63 |
| Antimicrobial | Acticide ® M20 | 0.1 |
| | (stock solution) | |
| Carbon Black Pigment | Monarch ® 1300 | 10 |
| Latex Particles | Acrylic Latex Dispersion | 30 |
| | (40 wt. % solids) | |
| Water | Deionized Water | Balance |

Tergitol® is available from Sigma Aldrich (USA); Acticide® is available from Thor Group Limited (USA); and Monarch® is available from Cabot Corporation (USA).

### Example 3—Evaluation of Gas-Precursor Fluid in Formation of 3D Breakaway Interface

A 70 μm single layer of spherical stainless steel (316L) particles having a D50 particle size of 15 μm was dispersed evenly on a substrate. The binder fluid of Table 1 was selectively ejected from a thermal inkjet printhead thereon to form a green body 3D object layer (which could also be used to form a green body 3D support structure). At another area of the layer of spherical stainless steel particles, the same type of thermal inkjet printhead was used to eject the gas-precursor fluid of Table 2A thereon. The green body layer was then heated 30 minutes at 180° C. to remove solvent, causing the latex to enhance in its binding strength, etc. The green body was then transferred to a furnace set at 1350° C. and sintered in a 98% nitrogen and 2% hydrogen gas-containing atmosphere.

Upon visual inspection of the printed object layer after sintering, the area of the 3D printed object corresponding to a printed location of gas-precursor fluid (printed in a line) included several extra pores in the body of the printed and sintered object, e.g., a line of pores were formed corresponding to the location of the printed gas-precursor.

The formation of pores corresponding to the location of the printed gas-precursor indicated the formation of methane gas bubbles where carbon in the gas-precursor interacted with hydrogen in the atmosphere to form methane gas. The methane gas created pores resulted in a structurally compromised area that can be printed between a support and a 3D object. The pores can provide a mechanism for separation of support structure(s) from the printed 3D object. The ability to create structurally comprised, breakable or removable areas can allow for the use of supports in the printing process which can be used to reduce or prevent deformation of sections of the green body and/or 3D object that can otherwise sag during printing and/or fusing.

What is claimed is:

1. A three-dimensional printing kit comprising:
a binder fluid including latex particles and an aqueous liquid vehicle;
a gas-precursor fluid including carbon black pigment dispersed in a second aqueous liquid vehicle; and
a particulate build material including metal particles.

2. The three-dimensional printing kit of claim 1, wherein
the latex particles are present in the binder fluid in an amount of from about 2 wt % to about 40 wt % based on the total weight of the binder fluid, and
the carbon black pigment is present in the gas-precursor fluid at an amount of from about 1 wt % to about 50 wt % based on the total weight of the gas-precursor fluid.

3. The three-dimensional printing kit of claim 1, wherein the gas-precursor fluid further comprises organic co-solvent and a dispersing agent attached to or associated with a surface of the carbon black pigment.

4. The three-dimensional printing kit of claim 1, wherein the gas-precursor fluid is devoid of latex particles.

5. The three-dimensional printing kit of claim 1, wherein the particulate build material includes from about 80 wt % to 100 wt % metal particles based on a total weight of the particulate build material.

6. The three-dimensional printing kit of claim 5, wherein the metal particles have a D50 particle size distribution value of from about 0.5 μm to about 200 μm.

7. A method of three-dimensional printing comprising:
iteratively applying individual build material layers of a particulate build material including metal particles;
based on a 3D model which includes a 3D object model, a 3D support structure model, and a 3D breakaway interface model, building a layered green body by:
selectively applying a binder fluid including latex particles dispersed in an aqueous liquid vehicle to individual build material layers to define individually patterned object layers of a 3D object based on the 3D object model and individually patterned support structure layers of a 3D support structure based on the 3D support structure model, and
selectively applying a gas-precursor fluid including carbon black pigment dispersed in a second aqueous liquid vehicle to individual build material layers to define individually patterned breakaway interface layers of a 3D breakaway interface based on the 3D breakaway interface model; and
heating the layered green body in an inert atmosphere containing hydrogen gas to form a fused 3D support structure, a fused 3D object, and a fused 3D breakaway interface therebetween that is weakened by methane gas bubbles generated by reaction between the carbon black pigment and the hydrogen gas.

8. The method of claim 7, wherein the fused 3D breakaway interface is positioned between the fused 3D support structure and the fused 3D object and has a thickness from about 10 μm to about 2,000 μm.

9. The method of claim 7, further comprising cooling the fused 3D support structure and the fused 3D object, and separating the fused 3D support structure from the fused 3D object along the fused 3D breakaway interface.

10. The method of claim 7, wherein the heating occurs at a temperature in the range of from about 600° C. to about 1,500° C., including a temperature within the range where the methane gas bubbles becomes trapped between object layers and support structure layers while being fused.

11. The method of claim 7, wherein the inert atmosphere is oxygen-free and includes a noble gas, an inert gas, or combination thereof, and wherein the hydrogen is present in an amount of from about 0.5 wt % to less than 100 wt %.

12. The method of claim 7, wherein the inert atmosphere is 100% hydrogen gas.

13. A three-dimensional printing kit comprising:
a binder fluid including latex particles dispersed in an aqueous liquid vehicle;
a gas-precursor fluid including latex particles and carbon black pigment dispersed in a second aqueous liquid vehicle; and
a particulate build material including metal particles.

14. The three-dimensional printing kit of claim 13, wherein the latex particles in the binder fluid and the latex particles in the gas-precursor fluid are the same.

15. The three-dimensional printing kit of claim 13, wherein the particulate build material includes from about 80 wt % to 100 wt % metal particles having a D50 particle size distribution value of from about 0.5 μm to about 200 μm, based on a total weight of the particulate build material.
